(19) United States
(12) Patent Application Publication
(10) Pub. No.: US 2025/0158789 A1
(43) Pub. Date: May 15, 2025

(54) CONFIGURING WAVEFORM TRANSMISSIONS FOR PASSIVE DEVICE ACTIVATION

(71) Applicant: QUALCOMM Incorporated, San Diego, CA (US)

(72) Inventors: Zhikun WU, Beijing (CN); Yuchul KIM, San Diego, CA (US); Ahmed ELSHAFIE, San Diego, CA (US); Huilin XU, Temecula, CA (US); Yu ZHANG, San Diego, CA (US); Kianoush HOSSEINI, San Diego, CA (US); Linhai HE, San Diego, CA (US)

(21) Appl. No.: 18/838,337

(22) PCT Filed: Apr. 6, 2022
(86) PCT No.: PCT/CN2022/085287

§ 371 Date: Aug. 14, 2024

(51) Int. Cl. H04L 5/00; H04W 52/14; H04W 52/46

(52) U.S. Cl. CPC H04L 5/0064; H04W 52/146; H04W 52/46

(57) ABSTRACT

Methods, systems, and devices for wireless communications are described. An active wireless device, such as a user equipment (UE), a network entity, or both, may receive or otherwise determine a resource allocation for communication with a passive device. The active device may select one or more parameters of a waveform transmission (e.g., a transmission power, duration, or both) for activating the passive device while accounting for a time gap between resources. In some cases, a network entity may configure a list of parameters including the one or more parameters via control signaling. The active device may transmit the waveform transmission to the passive device in accordance with the one or more parameters, which may activate the passive device.

### CROSS REFERENCE

The present Application is a 371 national phase filing of International PCT Application No. PCT/CN2022/085287 by WU et al., entitled “CONFIGURING WAVEFORM TRANSMISSIONS FOR PASSIVE DEVICE ACTIVATION,” filed Apr. 6, 2022, which is assigned to the assignee hereof, and which is expressly incorporated by reference in its entirety herein.

### FIELD OF TECHNOLOGY

The following relates to wireless communications, including configuring waveform transmissions for passive device activation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support configuring waveform transmissions for passive device activation. For example, the described techniques provide for a wireless device (e.g., a reader) may select one or more waveform transmission parameters for activating a passive device, where the waveform transmission may be a continuous wave transmission (e.g., a continuous, unmodulated wave), a modulated transmission, a multi-tone transmission, or any other type of transmission. For example, the wireless device, which may be a user equipment (UE), a reader, or a network entity, may receive a resource allocation for communication with a passive device. In some cases, a network entity may transmit control signaling that indicates a relationship between a duration of a time gap between resources and the one or more parameters (e.g., directly or in a list), such that the wireless device may select a duration of the waveform transmission, a transmission power level of the waveform transmission, or the like. The wireless device may transmit the waveform transmission to the passive device to activate the passive device while accounting for the gap between resources.

A method for wireless communication at a wireless device is described. The method may include selecting a first parameter of a waveform transmission for activating a passive device based on a time gap occurring between a first resource of a set of multiple resources and a second resource of the set of multiple resources, feedback indicating unsuccessful reception by the passive device of a prior message transmitted by the wireless device, or both, and transmitting the waveform transmission in accordance with the first parameter.

An apparatus for wireless communication at a wireless device is described. The apparatus may include a processor, memory coupled with the processor, and instructions stored in the memory. The instructions may be executable by the processor to cause the apparatus select a first parameter of a waveform transmission for activating a passive device based on a time gap occurring between a first resource of a set of multiple resources and a second resource of the set of multiple resources, feedback indicating unsuccessful reception by the passive device of a prior message transmitted by the wireless device, or both, and transmit the waveform transmission in accordance with the first parameter.

Another apparatus for wireless communication at a wireless device is described. The apparatus may include means for means for selecting a first parameter of a waveform transmission for activating a passive device based on a time gap occurring between a first resource of a set of multiple resources and a second resource of the set of multiple resources, feedback indicating unsuccessful reception by the passive device of a prior message transmitted by the wireless device, or both, and means for transmitting the waveform transmission in accordance with the first parameter.

A non-transitory computer-readable medium storing code for wireless communication at a wireless device is described. The code may include instructions executable by a processor to select a first parameter of a waveform transmission for activating a passive device based on a time gap occurring between a first resource of a set of multiple resources and a second resource of the set of multiple resources, feedback indicating unsuccessful reception by the passive device of a prior message transmitted by the wireless device, or both and transmit the waveform transmission in accordance with the first parameter.

Some examples of the method, apparatuses, and non-transitory computer-readable medium described herein may further include operations, features, means, or instructions for receiving a resource allocation indicating a set of multiple resources allocated for communication with the passive device.

Some examples of the method, apparatuses, and non-transitory computer-readable medium described herein may further include operations, features, means, or instructions for receiving control signaling indicating a relationship between a duration of the time gap and the first parameter that may be a duration of the waveform transmission.

Some examples of the method, apparatuses, and non-transitory computer-readable medium described herein may further include operations, features, means, or instructions for receiving control signaling indicating a relationship between a duration of the time gap and the first parameter that may be a transmission power level of the waveform transmission.

In some examples of the method, apparatuses, and non-transitory computer-readable medium described herein, the first parameter includes a waveform transmission power level, a duration of the waveform transmission, or both.

Some examples of the method, apparatuses, and non-transitory computer-readable medium described herein may further include operations, features, means, or instructions for receiving control signaling indicating a list including at least the first parameter of the waveform transmission for activating the passive device.

Some examples of the method, apparatuses, and non-transitory computer-readable medium described herein may further include operations, features, means, or instructions for transmitting a capability message indicating one or more capabilities of the wireless device and receiving, based on the capability message, the control signaling indicating the list including at least the first parameter of the waveform transmission.

In some examples of the method, apparatuses, and non-transitory computer-readable medium described herein, the one or more capabilities include a target communication range, an antenna gain, a defined transmission power level, a number of wireless devices in communication with the passive device, or any combination thereof.

Some examples of the method, apparatuses, and non-transitory computer-readable medium described herein may further include operations, features, means, or instructions for selecting a second parameter of a retransmission of the waveform transmission for activating the passive device and transmitting the retransmission of the waveform transmission in accordance with the second parameter.

Some examples of the method, apparatuses, and non-transitory computer-readable medium described herein may further include operations, features, means, or instructions for selecting the second parameter may be based on failing to receive a feedback message for the waveform transmission, a cyclic redundancy check (CRC) decode error, packet loss at the passive device, or any combination thereof.

In some examples of the method, apparatuses, and non-transitory computer-readable medium described herein, the second parameter corresponds to a longer duration of the waveform transmission than indicated by the first parameter, a higher transmission power level of the waveform transmission than indicated by the first parameter, or both.

Some examples of the method, apparatuses, and non-transitory computer-readable medium described herein may further include operations, features, means, or instructions for communicating one or more messages with one or more additional wireless devices to jointly activate the passive device, where selecting of the first parameter may be based on the one or more messages.

Some examples of the method, apparatuses, and non-transitory computer-readable medium described herein may further include operations, features, means, or instructions for transmitting the waveform transmission in accordance with the first parameter and transmitting a data transmission in accordance with a second parameter, where the first parameter includes a first transmission power level and the second parameter includes a second transmission power level that may be different than the first transmission power level.

In some examples of the method, apparatuses, and non-transitory computer-readable medium described herein, the feedback is a negative acknowledgement (NACK) of the prior message, absence of a feedback message for the prior message, a CRC error associated with the prior message, a packet error associated with the prior message, or any combination thereof.

In some examples of the method, apparatuses, and non-transitory computer-readable medium described herein, the passive device includes an IoT device or backscattering device (e.g., backscatter-capable device).

A method for wireless communication at a network entity is described. The method may include transmitting a control message indicating a list of a set of multiple parameters of a waveform transmission for activating a passive device and transmitting a resource allocation indicating a set of multiple resources allocated for communication between a wireless device and the passive device, the resource allocation including a time gap between a first resource of the set of multiple resources and a second resource of the set of multiple resources.

An apparatus for wireless communication at a network entity is described. The apparatus may include a processor, memory coupled with the processor, and instructions stored in the memory. The instructions may be executable by the processor to cause the apparatus to transmit a control message indicating a list of a set of multiple parameters of a waveform transmission for activating a passive device and transmit a resource allocation indicating a set of multiple resources allocated for communication between a wireless device and the passive device, the resource allocation including a time gap between a first resource of the set of multiple resources and a second resource of the set of multiple resources.

Another apparatus for wireless communication at a network entity is described. The apparatus may include means for transmitting a control message indicating a list of a set of multiple parameters of a waveform transmission for activating a passive device and means for transmitting a resource allocation indicating a set of multiple resources allocated for communication between a wireless device and the passive device, the resource allocation including a time gap between a first resource of the set of multiple resources and a second resource of the set of multiple resources.

A non-transitory computer-readable medium storing code for wireless communication at a network entity is described. The code may include instructions executable by a processor to transmit a control message indicating a list of a set of multiple parameters of a waveform transmission for activating a passive device and transmit a resource allocation indicating a set of multiple resources allocated for communication between a wireless device and the passive device, the resource allocation including a time gap between a first resource of the set of multiple resources and a second resource of the set of multiple resources.

Some examples of the method, apparatuses, and non-transitory computer-readable medium described herein may further include operations, features, means, or instructions for transmitting control signaling indicating a relationship between a duration of the time gap and at least one parameter of the set of multiple parameters that may be a duration of the waveform transmission.

Some examples of the method, apparatuses, and non-transitory computer-readable medium described herein may further include operations, features, means, or instructions for transmitting control signaling indicating a relationship between a duration of the time gap and at least one parameter of the set of multiple parameters that may be a transmission power level of the waveform transmission.

Some examples of the method, apparatuses, and non-transitory computer-readable medium described herein may further include operations, features, means, or instructions for receiving a capability message indicating one or more capabilities of the wireless device and transmitting, based on the capability message, the control message indicating the list of the set of multiple parameters.

In some examples of the method, apparatuses, and non-transitory computer-readable medium described herein, the one or more capabilities include a target communication range, an antenna gain, a defined transmission power level, a number of wireless devices in communication with the passive device, or any combination thereof.

Some examples of the method, apparatuses, and non-transitory computer-readable medium described herein may further include operations, features, means, or instructions for determining the set of multiple parameters based on a target communication range, an antenna gain at the UE, a number of wireless devices in communication with the passive device, or any combination thereof.

In some examples of the method, apparatuses, and non-transitory computer-readable medium described herein, the set of multiple parameters include a waveform transmit power, a waveform transmission duration, or any combination thereof.

In some examples of the method, apparatuses, and non-transitory computer-readable medium described herein, the passive device includes an IoT device or backscattering device (e.g., backscatter-capable device).

### BRIEF DESCRIPTION OF THE DRAWINGS

FIGS. 1 and 2 illustrate examples of wireless communications systems that support configuring waveform transmissions for passive device activation in accordance with one or more aspects of the present disclosure.

FIGS. 3A, 3B, and 4 illustrate examples of transmission diagrams that support configuring waveform transmissions for passive device activation in accordance with one or more aspects of the present disclosure.

FIG. 5 illustrates an example of a process flow that supports configuring waveform transmissions for passive device activation in accordance with one or more aspects of the present disclosure.

FIGS. 6 and 7 show block diagrams of devices that support configuring waveform transmissions for passive device activation in accordance with one or more aspects of the present disclosure.

FIG. 8 shows a block diagram of a communications manager that supports configuring waveform transmissions for passive device activation in accordance with one or more aspects of the present disclosure.

FIG. 9 shows a diagram of a system including a device that supports configuring waveform transmissions for passive device activation in accordance with one or more aspects of the present disclosure.

FIGS. 10 and 11 show block diagrams of devices that support configuring waveform transmissions for passive device activation in accordance with one or more aspects of the present disclosure.

FIG. 12 shows a block diagram of a communications manager that supports configuring waveform transmissions for passive device activation in accordance with one or more aspects of the present disclosure.

FIG. 13 shows a diagram of a system including a device that supports configuring waveform transmissions for passive device activation in accordance with one or more aspects of the present disclosure.

FIGS. 14 through 18 show flowcharts illustrating methods that support configuring waveform transmissions for passive device activation in accordance with one or more aspects of the present disclosure.

### DETAILED DESCRIPTION

Some wireless communications systems may implement passive communication technologies. For example, a wireless communication system may include one or more passive devices (e.g., passive internet of things (IoT) devices that includes one or more capacitors instead of battery power or being connected to an external power source) and active devices (e.g., a device that includes a battery or is connected to an external power source) that may use a backscatter communication technique. The backscatter communication technique may provide for communications between an active device and a passive device without active radio frequency (RF) components at the passive device. In some cases, an active wireless device (e.g., a wireless tag reader device (WTRD)) may send signaling to a passive device (e.g., a wireless tag device (WTD)), and the passive device may use the energy from the signaling to power up and reflect or transmit additional signaling. However, the time-frequency resources the active device uses for the signaling to power up the passive device may be discontinuous in a time domain, which may cause gaps in power supplied to the passive devices.

As described herein, an active device may power a passive device based on a configured set of parameters, such as a transmit power, a waveform transmission duration, or both, that account for one or more gaps between time-frequency resources during which the passive device discharges. A network entity may configure the time-frequency resources at one or more active devices, such as user equipments (UEs), network entities, or both, that are in communication with passive devices. The active devices may select a transmit power, a waveform transmission duration, or both, individually or by coordinating with each other for charging up the passive device. The transmit power and waveform transmission duration may account for the gap duration between time-frequency resources. The network entity may provide a list of the set of parameters for the waveform transmission to the one or more active devices. For example, the network entity may determine the set of parameters in the list based on a target communication range, an antenna gain at the active devices, a number of active devices in communication with a passive device, or any combination thereof. The set of parameters may be dynamic for transmissions and retransmissions, such that the active devices may update the parameters based on feedback, or lack thereof, from the passive devices. Similarly, the active devices may adjust the set of parameters for transmission of the waveform to power up the passive device and for a data transmission, such as by reducing a transmit power for the data transmission.

Aspects of the disclosure are initially described in the context of wireless communications systems. Aspects of the disclosure are further described in the context of transmission diagrams and process flows. Aspects of the disclosure are further illustrated by and described with reference to apparatus diagrams, system diagrams, and flowcharts that relate to configuring waveform transmissions for passive device activation.

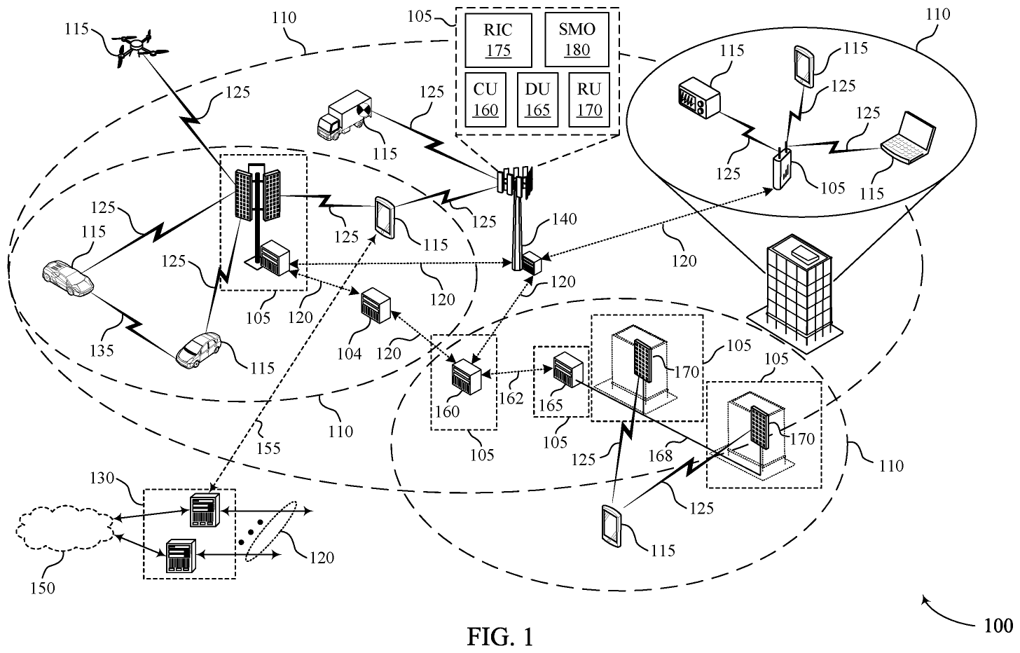

FIG. 1 illustrates an example of a wireless communications system 100 that supports configuring waveform transmissions for passive device activation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a RF access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support configuring waveform transmissions for passive device activation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some examples, an active device, such as a UE or a network entity, communicate with one or more passive devices. A passive device may be an example of a passive radio frequency identification (RFID) tag; a semi-passive RFID tag, where the RFID tag may use a battery to power the integrated circuit (IC); a semi-active RFID tag, where the RFID tag may generate signals in addition to having a battery or relying on backscattering techniques; or any combination thereof. Further, the passive device may be an IoT device or backscattering device (e.g., backscatter-capable device). Moreover, an RFID tag with a battery may power, or charge, the battery using energy harvesting techniques. For example, the active device and the passive devices may communicate in an IoT system using passive IoT technology, such as backscattering. Backscattering may be a technique in which a passive device may use RF signals to power up for data communications with an active device. Thus, a passive device may not have a power source, battery, or both, which may reduce power consumption and costs of the passive device. In some examples, passive devices in wireless communications system 100, may be continuously powered up by incident RF waves during communication. For example, the power from an electromagnetic signal (e.g., a waveform transmission) may be sufficient to activate the circuit of a passive device for one or more operations (e.g., transmitting, receiving, or reflecting signaling). In some cases, the passive device may charge a battery or temporarily power up using incident RF signals from an RF source (e.g., an RF reader), ambient RF signals from other transmissions, solar, thermal, light, or vibration energy harvesting techniques that may be implemented at the passive device, or any combination thereof.

Once the passive device no longer receives the electromagnetic signal, a capacitor of the passive device may discharge and the passive device may deactivate one the charge of its capacitor falls below a defined level. Additionally, or alternatively, of the passive device has a battery, the battery may discharge enough such that the passive device may deactivate. In some cases, time resources used for communication of an RF signal (e.g., a waveform transmission) by an active device may be discontinuous in a time domain, which may cause the passive device to deactivate due to lack of RF signaling received from the active device during in gaps in time between transmissions.

In some examples, an active device may select one or more parameters of a waveform transmission to activate a passive device to account for a gap in resources (e.g., time resources) for the waveform transmission, a data transmission after the waveform transmission, or both. In some cases, a network entity may allocate one or more resources to UEs 115 for communication with a passive device. The network entity 105 may transmit one or more waveform parameters to the UEs. In some examples, the waveform parameters may include a gap dependent waveform duration, where an active device may dynamically adjust the waveform transmission. The active devices may infer a suitable waveform duration according to the gap duration without an explicit indication of the waveform duration from the network entity 105. Additionally, or alternatively, the network entity 105 may define a relationship between transmission power level and waveform duration, such that an active device may infer a suitable waveform duration according to transmission power level without an explicit indication of the waveform duration from the network entity 105. An active device may select one or more parameters for a waveform transmission to the passive device, such as a transmit power level, a waveform duration, or both.

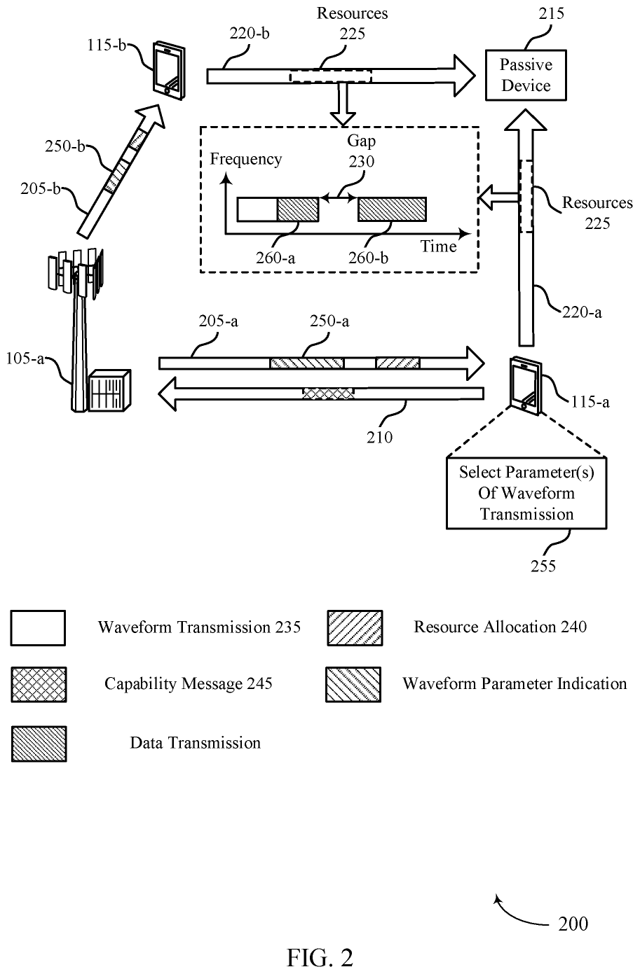

FIG. 2 illustrates an example of a wireless communications system 200 that supports configuring waveform transmissions for passive device activation in accordance with one or more aspects of the present disclosure. In some examples, wireless communications system 200 may implement aspects of wireless communications system 100 and may include a UE 115-a, a UE 115-b, and a network entity 105-a, which may be examples of UEs 115 and a network entity 105 as described with reference to FIG. 1. In some examples, network entity 105-a may communicate control information, data, or both with UE 115-a using a downlink communication link 205-a, with UE 115-b using a downlink communication link 205-b, or both. Similarly, UE 115-a, UE 115-b, or both may communicate control information, data or both with network entity 105-a using an uplink communication link, such as the uplink communication link 210 for UE 115-a.

In some examples, the network entity 105-a, the UE 115-a, the UE 115-b, or any combination thereof may be examples of active devices, which may communicate with one or more passive devices 215. For example, UE 115-a may communicate with a passive device 215 via a communication link 220-a, and UE 115-b may communicate with the passive device 215 via a communication link 220-b, which may be examples of communication links 125 as described with reference to FIG. 1. The active devices and the passive devices 215 may communicate in an IoT system using passive IoT technology, such as backscattering. Backscattering may be a technique in which a passive device may use RF signals to power up for data communications with an active device. Thus, a passive device may not have a power source, battery, or both, which may reduce power consumption and costs of the passive device. In some examples, an ultra-high frequency (UHF) RFID system may implement the backscatter communication techniques. For example, the RFID system may work in an industrial, scientific, and medical (ISM) frequency band, in contrast with NR systems which work primarily in licensed bands. In some cases, there may be no interference protocols between the different systems (e.g., the RFID system and an NR system), which may cause communication errors for use of a passive device 215 in NR systems.

In some examples, passive devices 215 in wireless communications system 200, which may be an NR system implementing IoT devices and communication techniques, may be continuously powered up by incident RF waves during communication. For example, each passive device 215 may be a tag with a chip, but no battery. The power from an electromagnetic signal may be sufficient to activate the circuit for one or more operations (e.g., transmitting, receiving, or reflecting signaling). Once the passive device no longer receives the electromagnetic signal, the passive device may deactivate. Similar systems, such as an RFID system may work in an ISM frequency band, which means an active device (e.g., an RFID transmitter or reader) may continuously occupy resources in the ISM frequency band. However, in the NR system, such as a TDD system, time resources (e.g., slots for uplink transmission) may be discontinuous in a time domain. A slot may be a dynamic scheduling unit for a transmission, where each slot may be further divided into one or more symbols. Each slot may be allocated for uplink communications, downlink communications, or both. Further, even in an FDD system, a scheduler may not schedule resources continuously in the time domain. However, an active device (e.g., reader) may perform communications with a short power up or repower up time for the passive device.

For example, the UE 115-a, the UE 115-b, or both may be active devices that communicates downlink transmissions, uplink transmissions, or both with the passive device 215 in a licensed band. In some other examples, the network entity 105-a may be the active device that communicates with the passive device 215. The passive device 215 may implement envelop decoding for receiving the uplink transmission from the active device, where envelope tracking and decoding may be a process by which a supply voltage being applied to an RF power amplifier may be continuously adjusted for power efficiency. Additionally, or alternatively, the passive device 215 may implement the backscatter techniques for transmitting a downlink transmission to the active device. For example, the passive device 215 may receive a RF wave (e.g., waveform transmission) to power up.

The waveform transmission may be a modulated signal, a time gap, a continuous wave transmission, a multi-tone transmission, or the like. In some cases, the multi-tone transmission may occur on one or more symbols (e.g., one or more OFDM symbols) transmitted on multiple subcarriers (e.g., frequencies or tones), which may be spaced according to a threshold distance, such as 15 kilohertz (kHz) in the frequency domain. In some cases, a charging rate of the passive device 215 may change from one waveform to the other. A multi-tone waveform may provide for an improved charging rate at the passive device 215 (e.g., an RFID tag). In an RFID system, an active device (e.g., UE 115-a, UE 115-b, or both) may continuously occupy a channel (e.g., for 0.5 seconds or more). However, one or more resources 225 allocated for communications between the active device and a passive device 215 scheduled in TDD systems or FDD systems may not be continuous in a time domain.

In some cases, discontinuous grants or resources 225 may result in loss of power (e.g., discharging of a capacitor) for a passive device 215. For example, there may be one or more gaps 230 between time resources allocated for a transmission. During the gap, a voltage in a capacitor of the passive device 215 may fall below a threshold value to activate the passive device. Data loss may occur if the voltage of the capacitor falls to a value below the turn on voltage of the IC of the passive device. For example, a gap of a defined duration (e.g., 400 microseconds (μs)) in which the passive device 215 does not receive a waveform transmission may result in a near complete discharge of its capacitor. In some cases, the waveform transmission may include a 100 μS duration to power up the passive device, the 100 μS duration may include 50 μs of signaling, 6 μs without signaling, and 44 μs with signaling. The passive device may discharge during the 6 μs without signaling.

In some examples, an active device may select one or more parameters of a waveform transmission 235 to activate a passive device 215 to account for a gap 230 in resources (e.g., time resources) for the waveform transmission 235, a data transmission after the waveform transmission 235, or both. A waveform transmission 235 may not have breaks, due to a lack of modulation. For example, an active device, such as UE 115-a, UE 115-b, or both may transmit one or more waveform transmissions 235 to a passive device by emitting an electromagnetic wave without breaks in time. In some cases, a network entity 105-a may allocate one or more resources 225 to UE 115-a, UE 115-b, or both for communication with the passive device 215. For example, the network entity 105-a may transmit a resource allocation 240 to UE 115-a, UE 115-b, or both in control signaling. The UE 115-a, UE 115-b, or both may use the resources 225 in the resource allocation 240 to transmit the waveform transmission 235, one or more data transmissions, or both. The resources 225 may include time-frequency resources.

In some cases, a UE, such as UE 115-a, may transmit a capability message 245 (e.g., in a capability report) that indicates to the network entity 105-a that the UE 115-a is capable of a target communication range, an antenna gain, a defined transmission power level, a number of UEs in communication with the passive device 215, or any combination thereof. The network entity 105-a may transmit one or more waveform parameters in a waveform parameter indication 250-a to UE 115-a after receiving the capability message 245 from UE 115-a. Additionally, or alternatively, the network entity 105-a may transmit the waveform parameter indication 250-a to UE 115-a independent of receiving the capability message 245. In some examples, the network entity 105-a may transmit a waveform parameter indication 250-b to UE 115-b, which may indicate different waveform parameters than the waveform parameter indication 250-a, or same waveform parameters.

In some examples, the waveform parameters may include a gap dependent waveform duration, where the waveform transmission 235 may be dynamically adjusted by an active device, such as the network entity 105-a, the UE 115-a, the UE 115-b, or any combination thereof. That is, the active device may adjust a duration of a waveform transmission 235 to a passive device 215 based on the length of the gap 230 between transmissions. For example, the UE 115-a may lengthen a waveform transmission 235 to ensure a capacitor of the passive device 215 maintains sufficient charge throughout the gap 230 without discharging past the threshold where the passive device 215 may deactivate. The network entity 105-a may define a gap duration (e.g., discharge duration, waveform duration, or the like) and a waveform duration relationship. In some examples, the network entity 105-a may signal the relationship to UE 115-a, UE 115-b, or both in the waveform parameter indication 250-a or the waveform parameter indication 250-b, respectively.

In some cases, the network entity 105-a may transmit the waveform parameter indications to active devices in control signaling, such as periodically via RRC signaling, aperiodically via a medium access control-control element (MAC-CE), or dynamically via downlink control information (DCI). The active devices (e.g., UE 115-a, UE 115-b, or both) may infer a suitable waveform duration according to the gap duration without an explicit indication of the waveform duration from the network entity 105-a. For example, the network entity 105-a may define a relationship between the duration of the gap 230 and a waveform duration, which is shown in Table 1. The UE 115-a, the UE 115-b, or both may use that relationship to autonomously determine one or more parameters (e.g., a waveform duration) for the waveform transmission 235. Each table, such as Table 1, may list a relationship between waveform transmission duration, transmission power level, or both, and time gap duration.

TABLE 1
Waveform transmission duration.

| Transmission | Gap Duration | | | |
|---|---|---|---|---|
| Power Level | >0.5 ms | >35 μs | >10 μs | |
| (dBm) | (1 slot) | (1 symbol) | (1 symbol) | <10 μs |
| 23 | 400 μs | 400 μs | 100 μs | 0 |
| | (12 symbols) | (12 symbols) | (3 symbols) | |
| 26 | 200 μs | 200 μs | 50 μs | 0 |
| | | | (2 symbols) | |
| 29 | 100 μs | 100 μs | 25 μs | 0 |
| | | | (1 symbols) | |

Additionally, or alternatively, as shown in Table 1, the network entity 105-a may define a relationship between transmission power level and waveform duration, such that an active device may infer a suitable waveform duration according to transmission power level without an explicit indication of the waveform duration from the network entity 105-a. For example, UE 115-a, UE 115-b, or both may use the defined relationship between the transmission power level and the waveform duration to autonomously determine one or more parameters (e.g., waveform duration and transmission power level) for the waveform transmission 235. Further, the network entity 105-a may define one or more relationships between the waveform duration and a communication range target (e.g., the range of a transmission from an active device), an antenna gain, a number of devices used to power up a passive device 215, or any combination thereof. In some examples, the network entity 105-a may define the one or more relationships as tables in control signaling (e.g., RRC signaling), algorithms or formulas in control signaling, or the like. That is, the network entity 105-a may provide control signaling, such as RRC signaling, to configure the active devices with tables, such as Table 1, so that the active devices may autonomously determine a waveform transmission duration, transmission power level, or both, without receiving explicit indications from the network entity 105-a about which waveform transmission duration, transmission power level, or both, to use.

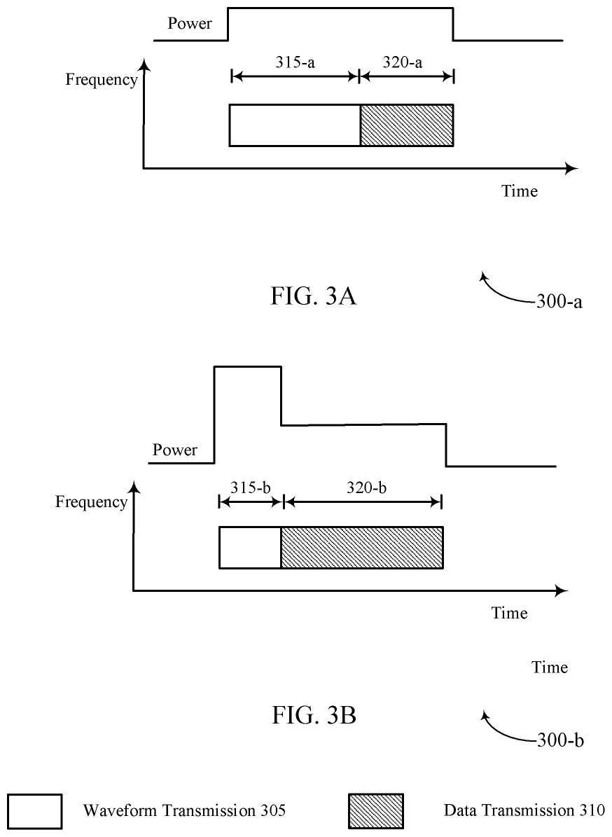

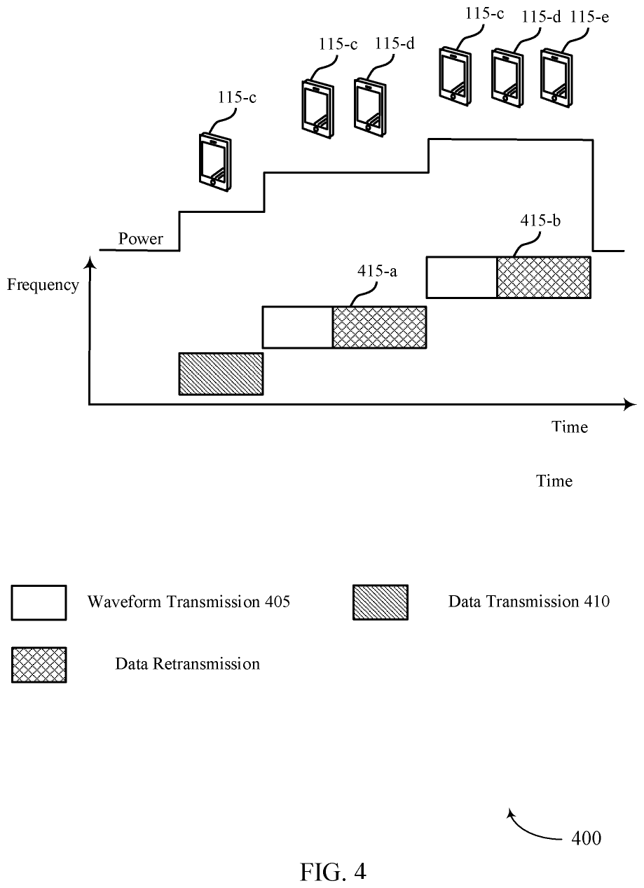

At 255, an active device, such as UE 115-a, may select one or more parameters for a waveform transmission to the passive device 215, such as a transmit power level, a waveform duration, or both. The UE 115-a may transmit the waveform transmission 235 using the selected parameters, which is described in further detail with respect to FIG. 3B. In some cases, the network entity 105-a may indicate to the UE 115-a and the UE 115-b to coordinate in activating the passive device 215, which is described in further detail with respect to FIG. 4. For example, UE 115-a may transmit a waveform transmission 235 concurrently, or at the same time as, a waveform transmission 235 from UE 115-b to produce a joint waveform transmission. The joint waveform transmission may use the power from both signals to power up the passive device 215, which may be faster or more efficient than using a single active device to activate the passive device 215.

In some examples, after the UE 115-a, the UE 115-b, or both activate the passive device 215, the UE 115-a and the UE 115-b may transmit one or more data transmissions to the passive device 215, such as data transmission 260-a, data transmission 260-b, or both. In some cases, the UE 115-a and the UE 115-b may provide a waveform transmission 235 with sufficient power and duration to activate the passive device 215 for the data transmission 260-a, the gap 230, and the data transmission 260-b. The UE 115-a and the UE 115-b may transmit the data transmission 260-a and the data transmission 260-b at a different transmission power level than the waveform transmission 235, such as a lower waveform transmission 235.

FIGS. 3A and 3B illustrate examples of a transmission diagram 300-a and a transmission diagram 300-b that support configuring waveform transmissions for passive device activation in accordance with one or more aspects of the present disclosure. In some examples, transmission diagram 300-a and transmission diagram 300-b may implement aspects of wireless communications system 100 and wireless communications system 200. For example, transmission diagram 300-a and transmission diagram 300-b may be implemented by a wireless communications system with one or more active devices and passive devices as described with reference to FIGS. 1 and 2. An active device, such as a UE or a network entity, may use a waveform transmission to activate a passive device while accounting for a gap between one or more time resources.

In some examples, an active device may perform a waveform transmission 305 to activate a passive device by transmitting signaling for a duration at a power level. For an RFID system, as illustrated in FIG. 3A, the active device may transmit at a constant power level for a waveform duration 315-a (e.g., 400-800 μs). The active device may not change the power level from the waveform transmission 305 to a data transmission 310 in the RFID system. For example, the active device may maintain a transmission power level for a data transmission duration 320-a. However, for an NR or LTE system, there may be gaps in time resources (e.g., between slots), that may cause the passive device to power down. Thus, the active device may autonomously adjust a waveform duration for a waveform transmission 305 based on a defined relationship, as described with reference to FIG. 2.

For example, as illustrated in FIG. 3B, an active device may increase a transmission power for a waveform transmission 305, which may subsequently reduce the transmission duration for the waveform transmission 305. That is, the waveform duration 315-b for powering up the passive device may be less than the waveform duration 315-a, and the transmission power level may be higher for the waveform duration 315-b than the waveform duration 315-a. The process of increasing the transmission power for a waveform transmission 305 may be referred to as an energy boost method. In some cases, the active device may transmit the waveform transmission 305 at a higher transmission power level than a data transmission 310 (e.g., boosted 6 decibels relative to one milliwatt (dBm)). In some examples, the waveform transmission 305 and the data transmission 310 may be sent to the passive device by a same active device. In some other examples, the waveform transmission 305 may be sent to the passive device by multiple active devices (e.g., four waveform transmission devices), which is described in further detail with respect to FIG. 4. Boosting the power for the waveform transmission 305 may increase the duration of a time resource, such as within a slot, allocated for the data transmission 310. For example, a data transmission duration 320-b may be longer than the data transmission duration 320-a. Thus, a waveform transmission 305 and a data packet may be in a single slot.

For example, if the waveform transmission duration 315-a takes 400 μs, and a slot is 500 μs, the data transmission duration may be 100 μs to remain in a single slot. However, after applying the 6 dBm power boost to the waveform transmission, a waveform transmission duration 315-b may take 100 μs, and the data transmission duration may be 400 μs to remain in a 500 μs slot.

FIG. 4 illustrates an example of a transmission diagram 400 that supports configuring waveform transmissions for passive device activation in accordance with one or more aspects of the present disclosure. In some examples, transmission diagram 400 may implement aspects of wireless communications system 100, wireless communications system 200, transmission diagram 300-a, and transmission diagram 300-b. For example, the transmission diagram 400 may be implemented by a wireless communications system with one or more active devices and passive devices as described with reference to FIGS. 1 and 2. Multiple active devices, such as UE 115-c through UE 115-h, network entities, or a combination of both, may use a waveform transmission to activate a passive device while accounting for a gap between one or more time resources, where the UE 115-c through UE 115-h may be example of UEs 115 as described with reference to FIGS. 1 and 2.

In some examples, one or more active devices may perform a waveform transmission 405 to activate a passive device by transmitting signaling for a duration at a power level. For example, a single active device (e.g., UE 115-c) may perform a waveform transmission 405 to activate a passive device for a data transmission 410. In some other examples, multiple active devices may coordinate to perform an energy boost to activate a passive device for a data transmission 410. In some cases, the one or more active devices may perform a waveform duration adjustment based on additional factors, such as an absence of a positive feedback message (e.g., an ACK), a CRC decode error, a data packet loss from the passive device, or the like. For example, the one or more active devices may receive an ACK from the passive device, and may reduce a waveform duration based on receiving the ACK. In some other examples, the one or more active devices may receive a NACK based on a CRC error or packet data loss, and may increase a waveform duration based on receiving the NACK, or not receiving a feedback message.

To improve reliability and reduce power, the active devices may dynamically perform transmission power adjustments, waveform duration adjustments, or both for data retransmissions. For example, one or more active devices may increase a waveform duration, transmission power level, or both for a data retransmission 415-a if the data transmission 410 is unsuccessful. Similarly, if the data retransmission 415-a is unsuccessful, one or more active devices may increase a waveform duration, transmission power level, or both for a data retransmission 415-b. The active devices may increase the parameters of the waveform transmission 405 until the data transmission 410, data retransmission 415-a, or retransmission 415-b are successful. Multiple active devices may coordinate with each other to activate the passive device, such as by transmitting waveforms concurrently.

In some examples, multiple devices may contribute to a waveform transmission 405. For example, UE 115-c may transmit the initial data transmission 410. UE 115-d may aid UE 115-c for a waveform transmission 405 that activates the passive device for the data retransmission 415-a. UE 115-e and UE 115-d may aid UE 115-c for a waveform transmission 405 that activates the passive device for the data retransmission 415-b.

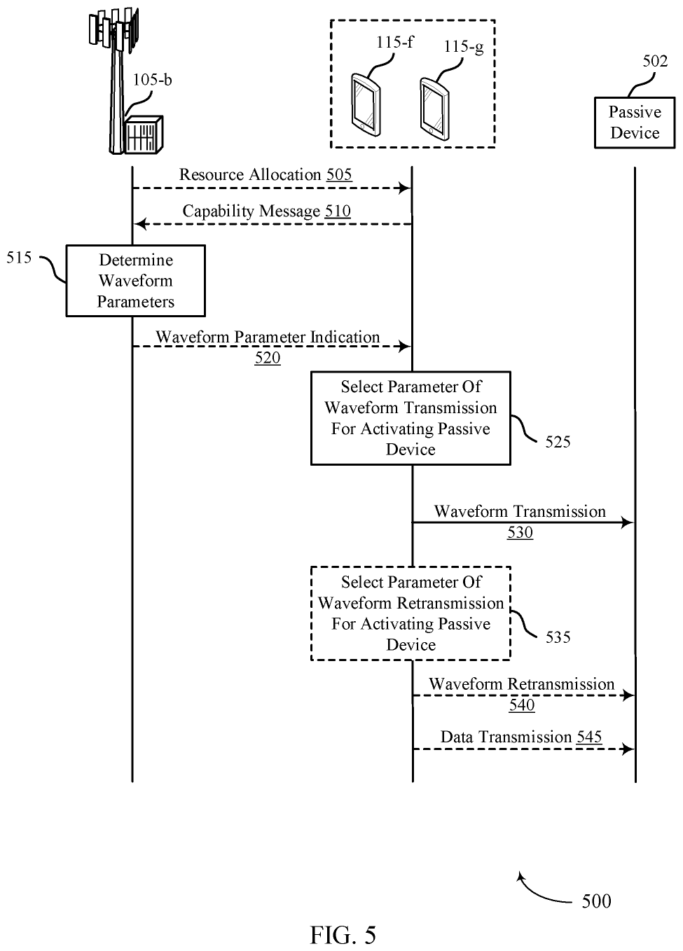

FIG. 5 illustrates an example of a process flow 500 that supports configuring waveform transmissions for passive device activation in accordance with one or more aspects of the present disclosure. In some examples, the process flow 500 may implement aspects of wireless communications system 100, wireless communications system 200, transmission diagram 300-a, transmission diagram 300-b, and transmission diagram 400. The process flow 500 may illustrate an example of one or more active devices, such as UE 115-f and UE 115-g, selecting parameters for a waveform transmission that activates a passive device 502. Network entity 105-b, UE 115-f, and UE 115-g may be examples of a network entity 105 and UEs 115 as described with reference to FIGS. 1 and 2, and may also be referred to as an active device. Alternative examples of the following may be implemented, where some processes are performed in a different order than described or are not performed. In some cases, processes may include additional features not mentioned below, or further processes may be added.

In some examples, one or more active devices (e.g., a network entity 105-b, a UE 115-f, a UE 115-g, or any combination thereof) may communicate with a passive device 502 in a wireless communications system, such as an IoT system. The passive device 502 may be an example of a reduced capability device without a power source, battery, or both that may use power from electromagnetic signals (e.g., a waveform transmission) to activate. The waveform transmission may be a continuous wave transmission, a modulated wave transmission, or any other type of signaling. The passive device 502 may have a circuit with a capacitor. Once the capacitor discharges below a threshold level, the passive device 502 may deactivate. In some examples, the active device may implement a continuous wave, or any other type of waveform, to activate the passive device 502.

At 505, the network entity 105-b may transmit a resource allocation to UE 115-f, UE 115-g, or both. The resource allocation may indicate time-frequency resources allocated for communication with a passive device 502, such as one or more slots, frequency bands, or the like allocated for the communication. The network entity 105-b may transmit the resource allocation in control signaling, such as in the form of a scheduling grant. In some cases, one or more resources may be discontinuous in a time domain, such that there may be a time gap separating different resources for transmission. In some examples, the passive device may include a passive RFID tag, a semi-passive RFID tag, or a semi-active RFID tag, an IoT device, or a backscattering device (e.g., backscatter-capable device). A passive RFID tag may not have a battery and may not be able to transmit signaling independent of an active device. A semi-passive RFID tag may have a batter to power an IC and may not be able to transmit signaling independent of an active device. A semi-active RFID tag may have a battery that may charge, or provide power, via energy harvesting techniques and may transmit signals.

At 510, the UE 115-f, the UE 115-g, or both may transmit a capability message to the network entity 105-b. The UE 115-f, the UE 115-g, or both may include the capability message as a field in a capability report, as a message separate from the capability report, or the like. The capability message may indicate one or more capabilities of UE 115-f, UE 115-g, or both, such as a target communication range, an antenna gain, a defined transmission power level, a number of UEs in communication with the passive device 502, or any combination thereof.

At 515, the network entity 105-b may determine one or more waveform parameters for a waveform transmission from one or more active devices to activate the passive device 502. For example, the network entity 105-b may determine a list of parameters based on a target communication range, an antenna gain at the UE, a number of UEs in communication with the passive device 502, or any combination thereof. In some cases, the network entity 105-b may determine a relationship between a gap duration separating resources in the time domain and a waveform transmission duration. Similarly, the network entity 105-b may determine a relationship between a transmission power level and a waveform transmission duration.

At 520, the network entity 105-b may transmit a waveform parameter indication to the UE 115-f, the UE 115-g, or both. For example, the network entity 105-b may transmit a control message indicating a list of parameters of a waveform transmission for activating a passive device 502. The list of parameters may be defined in one or more tables, as described with reference to FIG. 2. The control message may be included in RRC signaling, a MAC-CE, DCI, or the like. In some cases, the UE 115-f, the UE 115-g, or both may receive the control signaling indicating the list based on sending the capability message at 510. The list may include at least one parameter of the waveform transmission, such as a waveform transmission power level, a duration of the waveform transmission, or both.

In some cases, UE 115-f and UE 115-g may communicate one or more messages with each other to jointly activate the passive device 502. For example, UE 115-f and UE 115-g may coordinate a transmission power level, a waveform transmission duration, or both to jointly activate the passive device 502. The waveform parameter indication may be the same for UE 115-f and UE 115-g, or may be different depending on whether the UEs are jointly activating the passive device 502.

In some examples, the network entity 105-b may transmit control signaling indicating the relationship between a duration of the time gap and a parameter that is a duration of the waveform transmission. Additionally, or alternatively, the network entity 105-b may transmit control signaling indicating a relationship between a duration of the time gap and a parameter that is a transmission power level of the waveform transmission.

At 525, UE 115-f, UE 115-g, or both may select a parameter of a waveform transmission for activating the passive device 502. For example, the UE 115-f, the UE 115-g, or both may select the parameter based on the time gap occurring between resources. Additionally or alternatively, the UE 115-f, the UE 115-g, or both may select the parameter based on feedback associated with the passive device, or both. The feedback may indicate unsuccessful reception by the passive device 502 of a prior message transmitted by UE 115-f, UE 115-g, or both. The feedback may be a NACK of the prior message, absence of a feedback message (e.g., failure to receive an ACK for the prior message), a CRC error, a packet error, indication of a decoding error for the prior message by the passive device, poor reader decoding performance, or any combination thereof. In some examples, an active device (e.g., UE 115-f, UE 115-g, or both) may process feedback by internally determining feedback for a prior message due to an ACK not being received from a passive device 502 by the active device when expected. In some other examples, the active device may receive feedback from the passive device 502, such as an indication of a CRC decode error or of packet loss.

In some cases, network entity 105-b may signal the parameter at 520. In some cases, UE 115-f, UE 115-g, or both may infer a suitable waveform duration according to a gap duration, transmission power, or both without an explicit indication from network entity 105-b (e.g., based on the defined relationships). In some examples, the UE 115-f, the UE 115-g, or both may know from the resource allocation where one or more time gaps are between resource allocations. The UE 115-f, the UE 115-g, or both may use the time gaps to determine a waveform transmission duration, transmission power level, or both, for transmitting the waveform transmission and data transmission in the next resource allocation after the gap.

At 530, UE 115-f, UE 115-g, or both may transmit the waveform transmission in accordance with the parameter during a resource from the resource allocation. For example, UE 115-f, UE 115-g, or both may transmit the waveform transmission for a duration and at a power level that may ensure the passive device 502 remains active during a gap between transmission resources. In some examples, the UE 115-f, the UE 115-g, or both may transmit the waveform transmission with a boosted power according to an energy boost method.

In some examples, the UE 115-f, the UE 115-g, or both may transmit a data transmission after the waveform transmission at 530. For example, the waveform transmission may activate a passive device, and the UE 115-f, the UE 115-g, or both may transmit the data transmission during a time-frequency resource allocated for communications with the passive device. In some cases, the UE 115-f, the UE 115-g, or both may not receive an ACK, or may otherwise determine that the passive device may not have activated to receive the data transmission.

At 535, UE 115-f, UE 115-g, or both may select a parameter of a waveform for retransmission. In some cases, the parameter may be the same as, or different from, the parameter for the initial waveform transmission. For example, the UE 115-f, the UE 115-g, or both may select an increased duration or transmit power for the parameter based on failing to receive a feedback message for the data transmission (e.g., an ACK), a CRC decode error, packet loss at the passive device 502, or any combination thereof.

At 540, UE 115-f, UE 115-g, or both may transmit the waveform retransmission to activate the passive device 502 for a data transmission, a data retransmission or both. The UE 115-f, the UE 115-g, or both may transmit the waveform retransmission according to the selected parameter at 535. For example, the parameter may have a longer duration of the waveform retransmission, a higher transmission power level of the waveform retransmission, or both.

At 545, the UE 115-f, the UE 115-g, or both may transmit a data transmission based on activating the passive device 502. In some cases, the UE 115-f, the UE 115-g, or both may transmit the data transmission in accordance with a different parameter, which may be a reduced power level when compared with a power level for transmitting the waveform transmission at 530, the waveform retransmission at 540, or both.

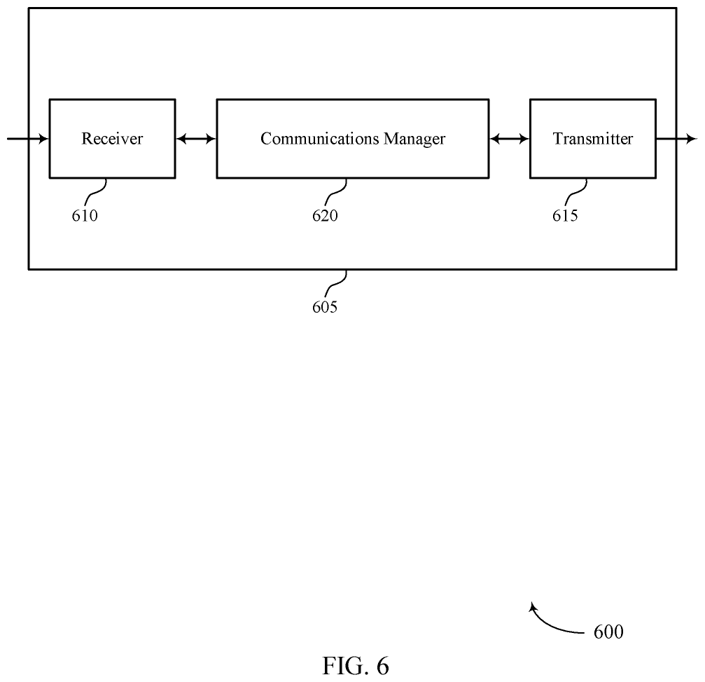

FIG. 6 shows a block diagram 600 of a device 605 that supports configuring waveform transmissions for passive device activation in accordance with one or more aspects of the present disclosure. The device 605 may be an example of aspects of a UE 115 (e.g., a wireless device) as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to configuring waveform transmissions for passive device activation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to configuring waveform transmissions for passive device activation). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of configuring waveform transmissions for passive device activation as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a wireless device (e.g., a UE) in accordance with examples as disclosed herein. For example, the communications manager 620 may be configured as or otherwise support a means for selecting a first parameter of a waveform transmission for activating a passive device based on a time gap occurring between a first resource of a set of multiple resources and a second resource of the set of multiple resources, feedback indicating unsuccessful reception by the passive device of a prior message transmitted by the wireless device, or both. The communications manager 620 may be configured as or otherwise support a means for transmitting the waveform transmission in accordance with the first parameter.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for an active device to select a parameter for a waveform transmission for activating a passive device while accounting for transmission gaps, which may provide for reduced processing, reduced power consumption, more efficient utilization of communication resources, and the like.

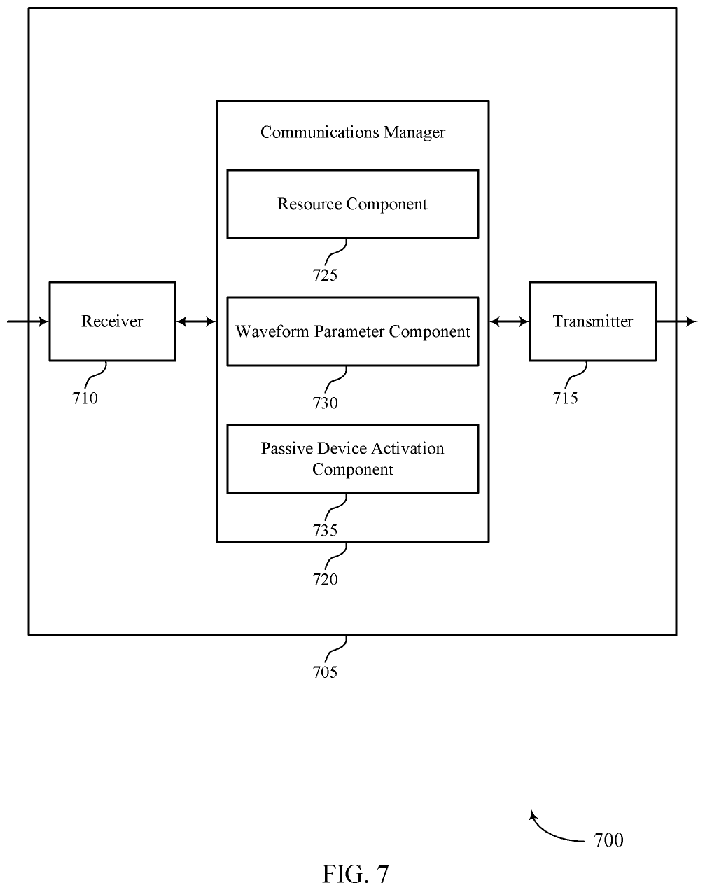

FIG. 7 shows a block diagram 700 of a device 705 that supports configuring waveform transmissions for passive device activation in accordance with one or more aspects of the present disclosure. The device 705 may be an example of aspects of a wireless device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to configuring waveform transmissions for passive device activation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to configuring waveform transmissions for passive device activation). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of configuring waveform transmissions for passive device activation as described herein. For example, the communications manager 720 may include a resource component 725, a waveform parameter component 730, a passive device activation component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a wireless device (e.g., a UE) in accordance with examples as disclosed herein. The resource component 725 may be configured as or otherwise support a means for selecting a first parameter of a waveform transmission for activating a passive device based on a time gap occurring between a first resource of a set of multiple resources and a second resource of the set of multiple resources, feedback indicating unsuccessful reception by the passive device of a prior message transmitted by the wireless device, or both. The passive device activation component 735 may be configured as or otherwise support a means for transmitting the waveform transmission in accordance with the first parameter.

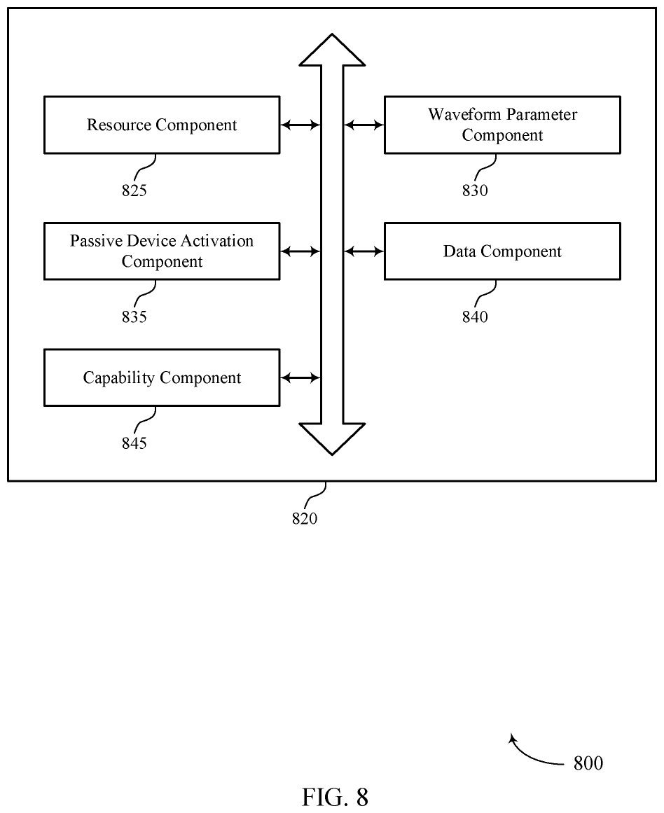

FIG. 8 shows a block diagram 800 of a communications manager 820 that supports configuring waveform transmissions for passive device activation in accordance with one or more aspects of the present disclosure. The communications manager 820 may be an example of aspects of a communications manager 620, a communications manager 720, or both, as described herein. The communications manager 820, or various components thereof, may be an example of means for performing various aspects of configuring waveform transmissions for passive device activation as described herein. For example, the communications manager 820 may include a resource component 825, a waveform parameter component 830, a passive device activation component 835, a data component 840, a capability component 845, or any combination thereof. Each of these components may communicate, directly or indirectly, with one another (e.g., via one or more buses).

The communications manager 820 may support wireless communication at a wireless device (e.g., a UE) in accordance with examples as disclosed herein. The resource component 825 may be configured as or otherwise support a means for receiving a resource allocation indicating a set of multiple resources allocated for communication with a passive device. The waveform parameter component 830 may be configured as or otherwise support a means for selecting a first parameter of a waveform transmission for activating the passive device based on a time gap occurring between a first resource of the set of multiple resources and a second resource of the set of multiple resources, feedback indicating unsuccessful reception by the passive device of a prior message transmitted by the wireless device, or both. The passive device activation component 835 may be configured as or otherwise support a means for transmitting the waveform transmission in accordance with the first parameter (e.g., during the second resource).

In some examples, the waveform parameter component 830 may be configured as or otherwise support a means for receiving control signaling indicating a relationship between a duration of the time gap and the first parameter that is a duration of the waveform transmission.

In some examples, the waveform parameter component 830 may be configured as or otherwise support a means for receiving control signaling indicating a relationship between a duration of the time gap and the first parameter that is a transmission power level of the waveform transmission.

In some examples, the first parameter includes a waveform transmission power level, a duration of the waveform transmission, or both.

In some examples, the feedback is a NACK of the prior message, absence of a feedback message for the prior message, a CRC error associated with the prior message, a packet error associated with the prior message, or any combination thereof.

In some examples, the passive device may include an IoT device or backscattering device (e.g., backscatter-capable device).

In some examples, the waveform parameter component 830 may be configured as or otherwise support a means for receiving control signaling indicating a list including at least the first parameter of the waveform transmission for activating the passive device.

In some examples, the capability component 845 may be configured as or otherwise support a means for transmitting a capability message indicating one or more capabilities of the wireless device (e.g., a UE). In some examples, the waveform parameter component 830 may be configured as or otherwise support a means for receiving, based on the capability message, the control signaling indicating the list including at least the first parameter of the waveform transmission.

In some examples, the one or more capabilities include a target communication range, an antenna gain, a defined transmission power level, a number of wireless devices (e.g., UEs) in communication with the passive device, or any combination thereof.

In some examples, the waveform parameter component 830 may be configured as or otherwise support a means for selecting a second parameter of a retransmission of the waveform transmission for activating the passive device. In some examples, the passive device activation component 835 may be configured as or otherwise support a means for transmitting the retransmission of the waveform transmission in accordance with the second parameter.

In some examples, selecting the second parameter is based on failing to receive a feedback message for the waveform transmission, a CRC decode error, packet loss at the passive device, or any combination thereof.

In some examples, the second parameter corresponds to a longer duration of the waveform transmission than indicated by the first parameter, a higher transmission power level of the waveform transmission than indicated by the first parameter, or both.

In some examples, the passive device activation component 835 may be configured as or otherwise support a means for communicating one or more messages with one or more additional wireless devices (e.g., UEs) to jointly activate the passive device, where selecting of the first parameter is based on the one or more messages.

In some examples, to support transmitting the waveform transmission in accordance with the first parameter, the passive device activation component 835 may be configured as or otherwise support a means for transmitting the waveform transmission in accordance with the first parameter. In some examples, to support transmitting the waveform transmission in accordance with the first parameter, the data component 840 may be configured as or otherwise support a means for transmitting a data transmission in accordance with a second parameter, where the first parameter includes a first transmission power level and the second parameter includes a second transmission power level that is different than the first transmission power level.

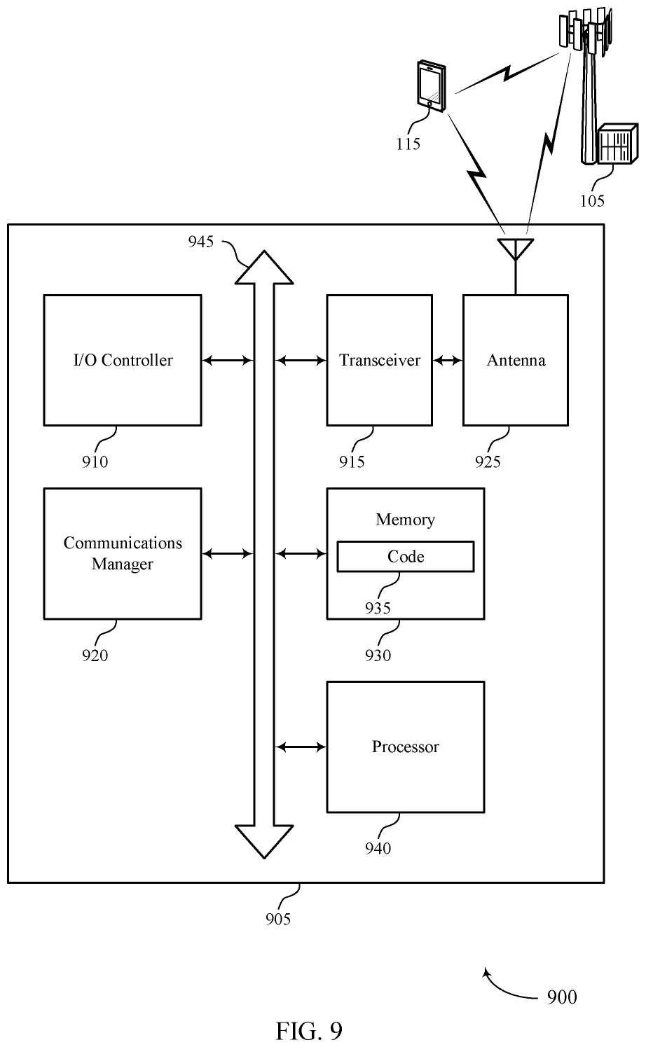

FIG. 9 shows a diagram of a system 900 including a device 905 that supports configuring waveform transmissions for passive device activation in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting configuring waveform transmissions for passive device activation). For example, the device 905 or a component of the device 905 may include a processor 940 and memory 930 coupled with or to the processor 940, the processor 940 and memory 930 configured to perform various functions described herein.

The communications manager 920 may support wireless communication at a wireless device (e.g., a UE, a gNB, or a network entity) in accordance with examples as disclosed herein. For example, the communications manager 920 may be configured as or otherwise support a means for selecting a first parameter of a waveform transmission for activating a passive device based on a time gap occurring between a first resource of a set of multiple resources and a second resource of the set of multiple resources, feedback indicating unsuccessful reception by the passive device of a prior message transmitted by the wireless device, or both. The communications manager 920 may be configured as or otherwise support a means for transmitting the waveform transmission in accordance with the first parameter.

By including or configuring the communications manager 920 in accordance with examples as described herein, the device 905 may support techniques for an active device to select a parameter for a waveform transmission for activating a passive device while accounting for transmission gaps, which may provide for improved communication reliability, reduced latency, improved user experience related to reduced processing, reduced power consumption, more efficient utilization of communication resources, improved coordination between devices, longer battery life, improved utilization of processing capability, and the like.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of configuring waveform transmissions for passive device activation as described herein, or the processor 940 and the memory 930 may be otherwise configured to perform or support such operations.

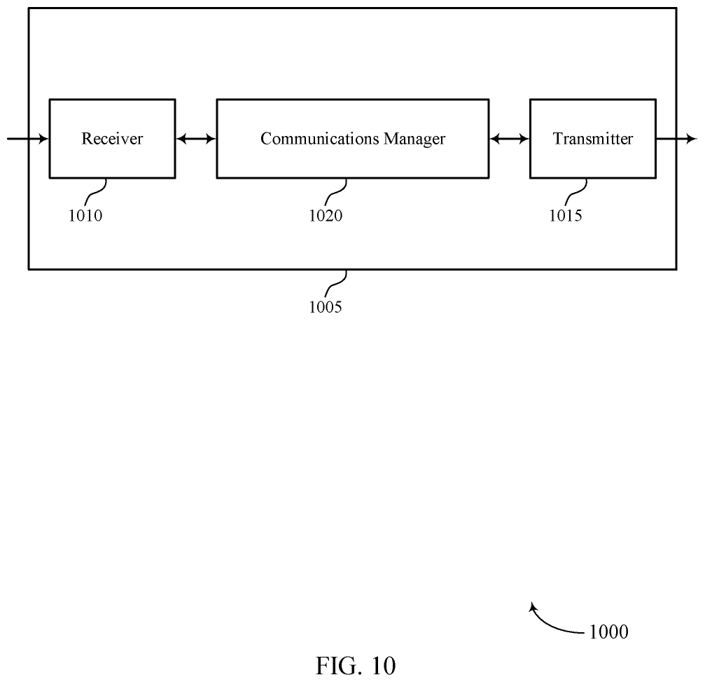

FIG. 10 shows a block diagram 1000 of a device 1005 that supports configuring waveform transmissions for passive device activation in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of configuring waveform transmissions for passive device activation as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for transmitting a control message indicating a list of a set of multiple parameters of a waveform transmission for activating a passive device. The communications manager 1020 may be configured as or otherwise support a means for transmitting a resource allocation indicating a set of multiple resources allocated for communication between a wireless device and the passive device, the resource allocation including a time gap between a first resource of the set of multiple resources and a second resource of the set of multiple resources.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for an active device to select a parameter for a waveform transmission for activating a passive device while accounting for transmission gaps, which may provide for reduced processing, reduced power consumption, more efficient utilization of communication resources, and the like.

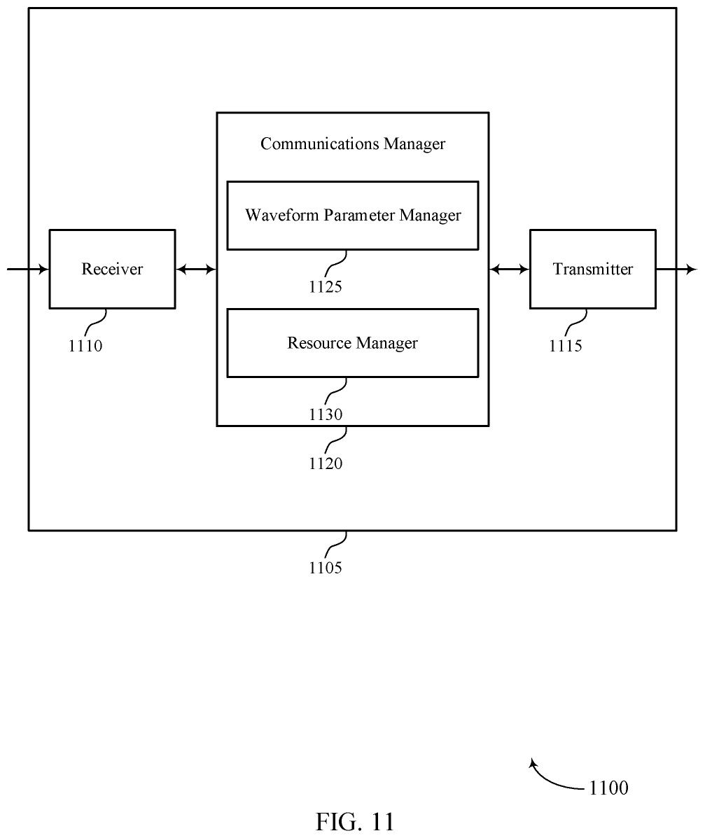

FIG. 11 shows a block diagram 1100 of a device 1105 that supports configuring waveform transmissions for passive device activation in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of configuring waveform transmissions for passive device activation as described herein. For example, the communications manager 1120 may include a waveform parameter manager 1125 a resource manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The waveform parameter manager 1125 may be configured as or otherwise support a means for transmitting a control message indicating a list of a set of multiple parameters of a waveform transmission for activating a passive device. The resource manager 1130 may be configured as or otherwise support a means for transmitting a resource allocation indicating a set of multiple resources allocated for communication between a wireless device and the passive device, the resource allocation including a time gap between a first resource of the set of multiple resources and a second resource of the set of multiple resources.

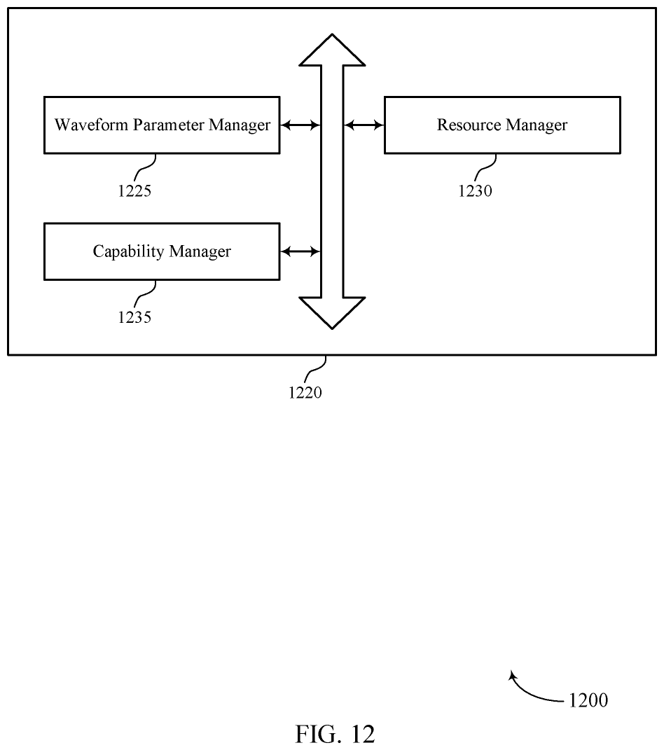

FIG. 12 shows a block diagram 1200 of a communications manager 1220 that supports configuring waveform transmissions for passive device activation in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of configuring waveform transmissions for passive device activation as described herein. For example, the communications manager 1220 may include a waveform parameter manager 1225, a resource manager 1230, a capability manager 1235, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The waveform parameter manager 1225 may be configured as or otherwise support a means for transmitting a control message indicating a list of a set of multiple parameters of a waveform transmission for activating a passive device. The resource manager 1230 may be configured as or otherwise support a means for transmitting a resource allocation indicating a set of multiple resources allocated for communication between a wireless device (e.g., a UE) and the passive device, the resource allocation including a time gap between a first resource of the set of multiple resources and a second resource of the set of multiple resources.

In some examples, the waveform parameter manager 1225 may be configured as or otherwise support a means for transmitting control signaling indicating a relationship between a duration of the time gap and at least one parameter of the set of multiple parameters that is a duration of the waveform transmission.

In some examples, the waveform parameter manager 1225 may be configured as or otherwise support a means for transmitting control signaling indicating a relationship between a duration of the time gap and at least one parameter of the set of multiple parameters that is a transmission power level of the waveform transmission.

In some examples, the capability manager 1235 may be configured as or otherwise support a means for receiving a capability message indicating one or more capabilities of the wireless device (e.g., UE). In some examples, the waveform parameter manager 1225 may be configured as or otherwise support a means for transmitting, based on the capability message, the control message indicating the list of the set of multiple parameters.

In some examples, the one or more capabilities include a target communication range, an antenna gain, a defined transmission power level, a number of wireless devices (e.g., UEs) in communication with the passive device, or any combination thereof.

In some examples, the passive device may include an IoT device or backscattering device (e.g., backscatter-capable device).

In some examples, the waveform parameter manager 1225 may be configured as or otherwise support a means for determining the set of multiple parameters based on a target communication range, an antenna gain at the wireless device (e.g., UE), a number of UEs in communication with the passive device, or any combination thereof.

In some examples, the set of multiple parameters include a waveform transmit power, a waveform transmission duration, or any combination thereof.

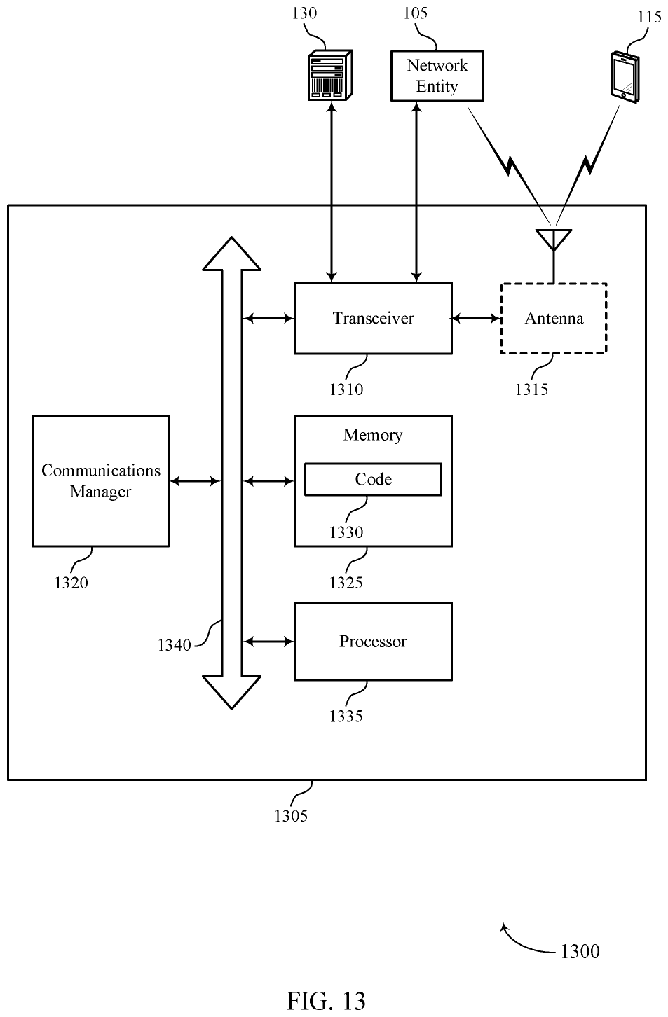

FIG. 13 shows a diagram of a system 1300 including a device 1305 that supports configuring waveform transmissions for passive device activation in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting configuring waveform transmissions for passive device activation). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for transmitting a control message indicating a list of a set of multiple parameters of a waveform transmission for activating a passive device. The communications manager 1320 may be configured as or otherwise support a means for transmitting a resource allocation indicating a set of multiple resources allocated for communication between a UE and the passive device, the resource allocation including a time gap between a first resource of the set of multiple resources and a second resource of the set of multiple resources.

By including or configuring the communications manager 1320 in accordance with examples as described herein, the device 1305 may support techniques for an active device to select a parameter for a waveform transmission for activating a passive device while accounting for transmission gaps, which may provide for improved communication reliability, reduced latency, improved user experience related to reduced processing, reduced power consumption, more efficient utilization of communication resources, improved coordination between devices, longer battery life, improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of configuring waveform transmissions for passive device activation as described herein, or the processor 1335 and the memory 1325 may be otherwise configured to perform or support such operations.

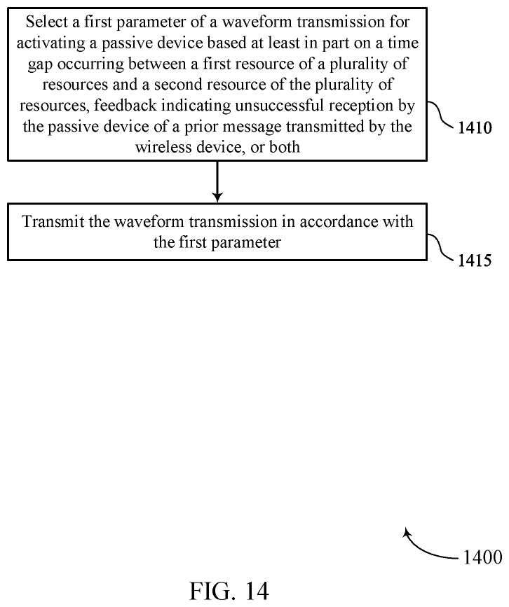

FIG. 14 shows a flowchart illustrating a method 1400 that supports configuring waveform transmissions for passive device activation in accordance with one or more aspects of the present disclosure. The operations of the method 1400 may be implemented by a wireless device (e.g., a UE, reader, gNB) or its components as described herein. For example, the operations of the method 1400 may be performed by a UE 115 as described with reference to FIGS. 1 through 9. In some examples, a wireless device may execute a set of instructions to control the functional elements of the wireless device to perform the described functions. Additionally, or alternatively, the wireless device may perform aspects of the described functions using special-purpose hardware.

At 1410, the method may include selecting a first parameter of a waveform transmission for activating a passive device based on a time gap occurring between a first resource of a set of multiple resources and a second resource of the set of multiple resources, feedback indicating unsuccessful reception by the passive device of a prior message transmitted by the wireless device, or both. The operations of 1410 may be performed in accordance with examples as disclosed herein. In some examples, aspects of the operations of 1410 may be performed by a waveform parameter component 830 as described with reference to FIG. 8.

At 1415, the method may include transmitting the waveform transmission in accordance with the first parameter (e.g., during the second resource). The operations of 1415 may be performed in accordance with examples as disclosed herein. In some examples, aspects of the operations of 1415 may be performed by a passive device activation component 835 as described with reference to FIG. 8.

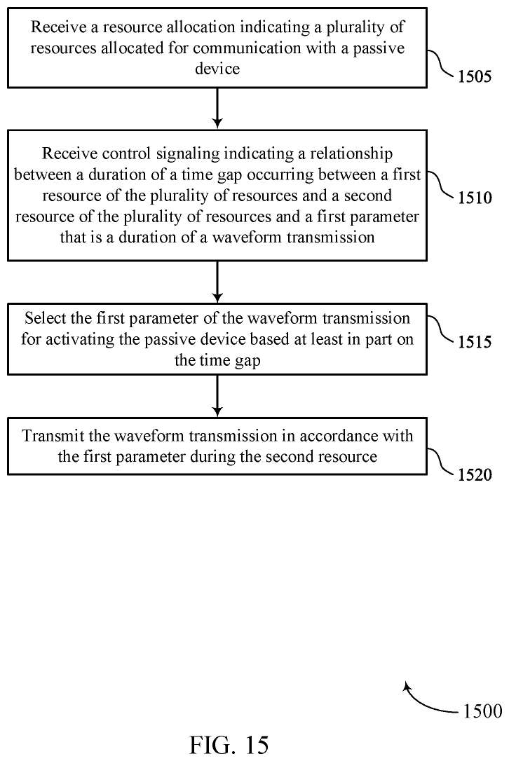

FIG. 15 shows a flowchart illustrating a method 1500 that supports configuring waveform transmissions for passive device activation in accordance with one or more aspects of the present disclosure. The operations of the method 1500 may be implemented by a wireless device (e.g., a UE, gNB, or a reader) or its components as described herein. For example, the operations of the method 1500 may be performed by a UE 115 as described with reference to FIGS. 1 through 9. In some examples, a wireless device may execute a set of instructions to control the functional elements of the UE to perform the described functions. Additionally, or alternatively, the wireless device may perform aspects of the described functions using special-purpose hardware.

At 1505, the method may include receiving a resource allocation indicating a set of multiple resources allocated for communication with a passive device. The operations of 1505 may be performed in accordance with examples as disclosed herein. In some examples, aspects of the operations of 1505 may be performed by a resource component 825 as described with reference to FIG. 8.

At 1510, the method may include receiving control signaling indicating a relationship between a duration of a time gap occurring between a first resource of the set of multiple resources and a second resource of the set of multiple resources and a first parameter that is a duration of a waveform transmission. The operations of 1510 may be performed in accordance with examples as disclosed herein. In some examples, aspects of the operations of 1510 may be performed by a waveform parameter component 830 as described with reference to FIG. 8.

At 1515, the method may include selecting the first parameter of the waveform transmission for activating the passive device based on the time gap. The operations of 1515 may be performed in accordance with examples as disclosed herein. In some examples, aspects of the operations of 1515 may be performed by a waveform parameter component 830 as described with reference to FIG. 8.

At 1520, the method may include transmitting the waveform transmission in accordance with the first parameter during the second resource. The operations of 1520 may be performed in accordance with examples as disclosed herein. In some examples, aspects of the operations of 1520 may be performed by a passive device activation component 835 as described with reference to FIG. 8.

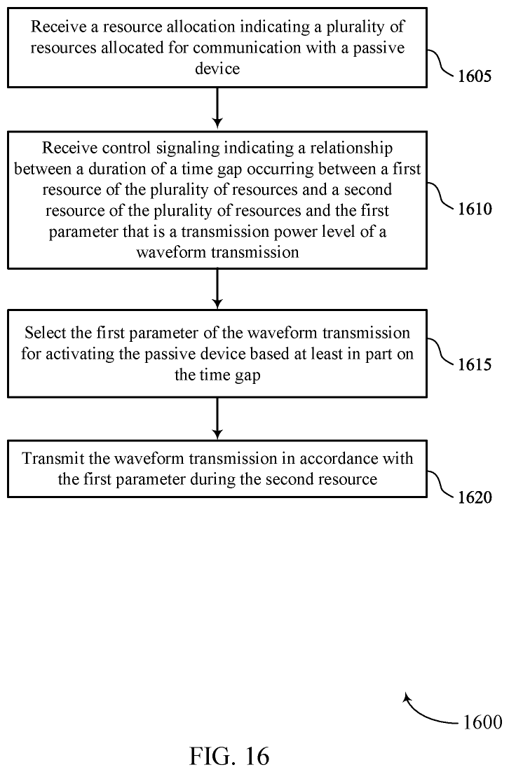

FIG. 16 shows a flowchart illustrating a method 1600 that supports configuring waveform transmissions for passive device activation in accordance with one or more aspects of the present disclosure. The operations of the method 1600 may be implemented by a wireless device (e.g., a UE, reader, gNB), or its components as described herein. For example, the operations of the method 1600 may be performed by a UE 115 as described with reference to FIGS. 1 through 9. In some examples, a wireless device may execute a set of instructions to control the functional elements of the wireless device to perform the described functions. Additionally, or alternatively, the wireless device may perform aspects of the described functions using special-purpose hardware.

At 1605, the method may include receiving a resource allocation indicating a set of multiple resources allocated for communication with a passive device. The operations of 1605 may be performed in accordance with examples as disclosed herein. In some examples, aspects of the operations of 1605 may be performed by a resource component 825 as described with reference to FIG. 8.

At 1610, the method may include receiving control signaling indicating a relationship between a duration of a time gap occurring between a first resource of the set of multiple resources and a second resource of the set of multiple resources and a first parameter that is a transmission power level of a waveform transmission. The operations of 1610 may be performed in accordance with examples as disclosed herein. In some examples, aspects of the operations of 1610 may be performed by a waveform parameter component 830 as described with reference to FIG. 8.

At 1615, the method may include selecting the first parameter of the waveform transmission for activating the passive device based on the time gap. The operations of 1615 may be performed in accordance with examples as disclosed herein. In some examples, aspects of the operations of 1615 may be performed by a waveform parameter component 830 as described with reference to FIG. 8.

At 1620, the method may include transmitting the waveform transmission in accordance with the first parameter during the second resource. The operations of 1620 may be performed in accordance with examples as disclosed herein. In some examples, aspects of the operations of 1620 may be performed by a passive device activation component 835 as described with reference to FIG. 8.

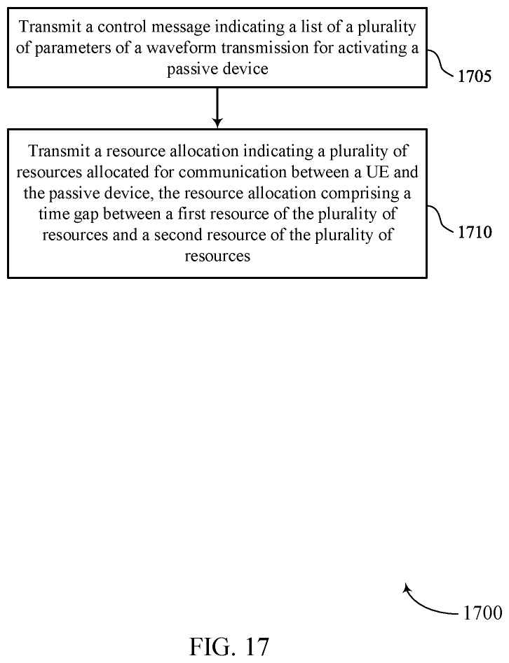

FIG. 17 shows a flowchart illustrating a method 1700 that supports configuring waveform transmissions for passive device activation in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting a control message indicating a list of a set of multiple parameters of a waveform transmission for activating a passive device. The operations of 1705 may be performed in accordance with examples as disclosed herein. In some examples, aspects of the operations of 1705 may be performed by a waveform parameter manager 1225 as described with reference to FIG. 12.

At 1710, the method may include transmitting a resource allocation indicating a set of multiple resources allocated for communication between a wireless device (e.g., a UE) and the passive device, the resource allocation including a time gap between a first resource of the set of multiple resources and a second resource of the set of multiple resources. The operations of 1710 may be performed in accordance with examples as disclosed herein. In some examples, aspects of the operations of 1710 may be performed by a resource manager 1230 as described with reference to FIG. 12.

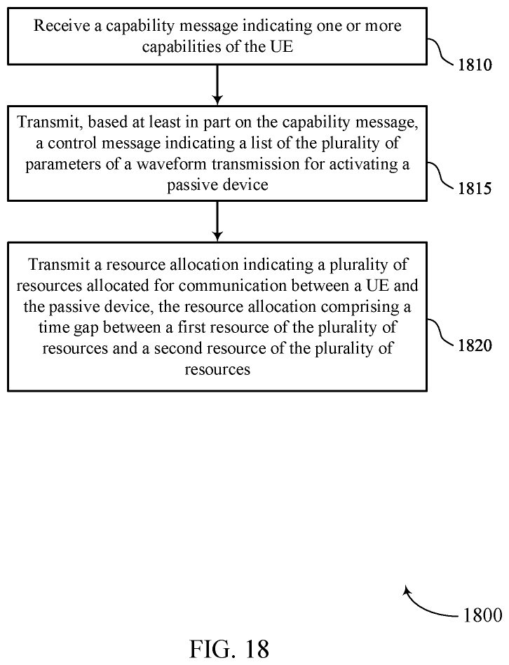

FIG. 18 shows a flowchart illustrating a method 1800 that supports configuring waveform transmissions for passive device activation in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1810, the method may include receiving a capability message indicating one or more capabilities of the wireless device. The operations of 1810 may be performed in accordance with examples as disclosed herein. In some examples, aspects of the operations of 1810 may be performed by a capability manager 1235 as described with reference to FIG. 12.

At 1815, the method may include transmitting, based on the capability message, the control message indicating a list of a set of multiple parameters of a waveform transmission for activating a passive device. The operations of 1815 may be performed in accordance with examples as disclosed herein. In some examples, aspects of the operations of 1815 may be performed by a waveform parameter manager 1225 as described with reference to FIG. 12.

At 1820, the method may include transmitting a resource allocation indicating a set of multiple resources allocated for communication between a wireless device (e.g., a UE) and the passive device, the resource allocation including a time gap between a first resource of the set of multiple resources and a second resource of the set of multiple resources. The operations of 1820 may be performed in accordance with examples as disclosed herein. In some examples, aspects of the operations of 1820 may be performed by a resource manager 1230 as described with reference to FIG. 12.

The following provides an overview of aspects of the present disclosure:
Aspect 1: A method for wireless communication at a wireless device, comprising: selecting a first parameter of a waveform transmission for activating a passive device based at least in part on a time gap occurring between a first resource of a plurality of resources and a second resource of the plurality of resources, feedback indicating unsuccessful reception by the passive device of a prior message transmitted by the wireless device, or both; and transmitting the waveform transmission in accordance with the first parameter.
Aspect 2: The method of aspect 1, further comprising receiving a resource allocation indicating the plurality of resources allocated for communication with the passive device.
Aspect 3: The method of aspect 1 and 2, further comprising receiving control signaling indicating a relationship between a duration of the time gap and the first parameter that is a duration of the waveform transmission.
Aspect 4: The method of any of aspects 1 through 3, further comprising receiving control signaling indicating a relationship between a duration of the time gap and the first parameter that is a transmission power level of the waveform transmission.
Aspect 5: The method of any of aspects 1 through 4, wherein the first parameter comprises a waveform transmission power level, a duration of the waveform transmission, or both.
Aspect 6: The method of any of aspects 1 through 5, further comprising receiving control signaling indicating a list comprising at least the first parameter of the waveform transmission for activating the passive device.
Aspect 7: The method of aspect 6, further comprising transmitting a capability message indicating one or more capabilities of the wireless device; and receiving, based at least in part on the capability message, the control signaling indicating the list comprising at least the first parameter of the waveform transmission.
Aspect 8: The method of aspect 7, wherein the one or more capabilities comprise a target communication range, an antenna gain, a defined transmission power level, a number of wireless devices (e.g., UEs) in communication with the passive device, or any combination thereof.
Aspect 9: The method of any of aspects 1 through 8, further comprising selecting a second parameter of a retransmission of the waveform transmission for activating the passive device; and transmitting the retransmission of the waveform transmission in accordance with the second parameter.
Aspect 10: The method of aspect 9, wherein selecting the second parameter is based at least in part on failing to receive a feedback message for the waveform transmission, a cyclic redundancy check decode error, packet loss at the passive device, or any combination thereof.
Aspect 11: The method of any of aspects 9 through 10, wherein the second parameter corresponds to a longer duration of the waveform transmission than indicated by the first parameter, a higher transmission power level of the waveform transmission than indicated by the first parameter, or both.
Aspect 12: The method of any of aspects 1 through 11, further comprising communicating one or more messages with one or more additional wireless devices to jointly activate the passive device, wherein selecting of the first parameter is based at least in part on the one or more messages.
Aspect 13: The method of any of aspects 1 through 12, wherein transmitting the waveform transmission in accordance with the first parameter comprises transmitting the waveform transmission in accordance with the first parameter; and transmitting a data transmission in accordance with a second parameter, wherein the first parameter comprises a first transmission power level and the second parameter comprises a second transmission power level that is different than the first transmission power level.
Aspect 14: The method of any of aspects 1 through 13, wherein the feedback is a negative acknowledgement of the prior message, absence of a feedback message for the prior message, a cyclic redundancy check error associated with the prior message, a packet error associated with the prior message, or any combination thereof.
Aspect 15: The method of any of aspects 1 through 14, wherein the passive device comprises an internet of things device or backscattering device.
Aspect 16: A method for wireless communication at a network entity, comprising: transmitting a control message indicating a list of a plurality of parameters of a waveform transmission for activating a passive device; and transmitting a resource allocation indicating a plurality of resources allocated for communication between a wireless device (e.g., a UE) and the passive device, the resource allocation comprising a time gap between a first resource of the plurality of resources and a second resource of the plurality of resources.
Aspect 17: The method of aspect 16, further comprising transmitting control signaling indicating a relationship between a duration of the time gap and at least one parameter of the plurality of parameters that is a duration of the waveform transmission.
Aspect 18: The method of any of aspects 16 through 17, further comprising transmitting control signaling indicating a relationship between a duration of the time gap and at least one parameter of the plurality of parameters that is a transmission power level of the waveform transmission.
Aspect 19: The method of any of aspects 16 through 18, further comprising receiving a capability message indicating one or more capabilities of the wireless device; and transmitting, based at least in part on the capability message, the control message indicating the list of the plurality of parameters.
Aspect 20: The method of aspect 19, wherein the one or more capabilities comprise a target communication range, an antenna gain, a defined transmission power level, a number of wireless devices (e.g., UEs) in communication with the passive device, or any combination thereof.
Aspect 21: The method of any of aspects 16 through 20, further comprising determining the plurality of parameters based at least in part on a target communication range, an antenna gain at the wireless device (e.g., a UE), a number of wireless devices (e.g., UEs) in communication with the passive device, or any combination thereof.
Aspect 22: The method of any of aspects 16 through 21, wherein the plurality of parameters comprise a waveform transmit power, a waveform transmission duration, or any combination thereof.
Aspect 23: The method of any of aspects 16 through 22, wherein the passive device comprises an internet of things device or backscattering device.
Aspect 24: An apparatus for wireless communication at a wireless device, comprising a processor; memory coupled with the processor; and instructions stored in the memory and executable by the processor to cause the apparatus to perform a method of any of aspects 1 through 15.
Aspect 25: An apparatus for wireless communication at a wireless device, comprising at least one means for performing a method of any of aspects 1 through 15.
Aspect 26: A non-transitory computer-readable medium storing code for wireless communication at a wireless device, the code comprising instructions executable by a processor to perform a method of any of aspects 1 through 15.
Aspect 27: An apparatus for wireless communication at a network entity, comprising a processor; memory coupled with the processor; and instructions stored in the memory and executable by the processor to cause the apparatus to perform a method of any of aspects 16 through 23.
Aspect 28: An apparatus for wireless communication at a network entity, comprising at least one means for performing a method of any of aspects 16 through 23.
Aspect 29: A non-transitory computer-readable medium storing code for wireless communication at a network entity, the code comprising instructions executable by a processor to perform a method of any of aspects 16 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a wireless device, comprising:
a processor;
memory coupled with the processor; and
instructions stored in the memory and executable by the processor to cause the apparatus to:
select a first parameter of a waveform transmission for activating a passive device based at least in part on a time gap occurring between a first resource of a plurality of resources and a second resource of the plurality of resources, feedback indicating unsuccessful reception by the passive device of a prior message transmitted by the wireless device, or both; and
transmit the waveform transmission in accordance with the first parameter.

2. The apparatus of claim 1, wherein the instructions are further executable by the processor to cause the apparatus to:
receive a resource allocation indicating the plurality of resources allocated for communication with the passive device.

3. The apparatus of claim 1, wherein the instructions are further executable by the processor to cause the apparatus to:
receive control signaling indicating a relationship between a duration of the time gap and the first parameter that is a duration of the waveform transmission.

4. The apparatus of claim 1, wherein the instructions are further executable by the processor to cause the apparatus to:
receive control signaling indicating a relationship between a duration of the time gap and the first parameter that is a transmission power level of the waveform transmission.

5. The apparatus of claim 1, wherein the first parameter comprises a waveform transmission power level, a duration of the waveform transmission, or both.

6. The apparatus of claim 1, wherein the instructions are further executable by the processor to cause the apparatus to:
receive control signaling indicating a list comprising at least the first parameter of the waveform transmission for activating the passive device.

7. The apparatus of claim 6, wherein the instructions are further executable by the processor to cause the apparatus to:
transmit a capability message indicating one or more capabilities of the wireless device; and
receive, based at least in part on the capability message, the control signaling indicating the list comprising at least the first parameter of the waveform transmission.

8. The apparatus of claim 7, wherein the one or more capabilities comprise a target communication range, an antenna gain, a defined transmission power level, a number of wireless devices in communication with the passive device, or any combination thereof.

9. The apparatus of claim 1, wherein the instructions are further executable by the processor to cause the apparatus to:
select a second parameter of a retransmission of the waveform transmission for activating the passive device; and
transmit the retransmission of the waveform transmission in accordance with the second parameter.

10. The apparatus of claim 9, wherein selecting the second parameter is based at least in part on failing to receive a feedback message for the waveform transmission, a cyclic redundancy check decode error, packet loss at the passive device, or any combination thereof.

11. The apparatus of claim 9, wherein the second parameter corresponds to a longer duration of the waveform transmission than indicated by the first parameter, a higher transmission power level of the waveform transmission than indicated by the first parameter, or both.

12. The apparatus of claim 1, wherein the instructions are further executable by the processor to cause the apparatus to:
communicate one or more messages with one or more additional wireless devices to jointly activate the passive device, wherein selecting of the first parameter is based at least in part on the one or more messages.

13. The apparatus of claim 1, wherein the instructions to transmit the waveform transmission in accordance with the first parameter are executable by the processor to cause the apparatus to:
transmit the waveform transmission in accordance with the first parameter; and
transmit a data transmission in accordance with a second parameter, wherein the first parameter comprises a first transmission power level and the second parameter comprises a second transmission power level that is different than the first transmission power level.

14. The apparatus of claim 1, wherein the feedback is a negative acknowledgement of the prior message, absence of a feedback message for the prior message, a cyclic redundancy check error associated with the prior message, a packet error associated with the prior message, or any combination thereof.

15. The apparatus of claim 1, wherein the passive device comprises an internet of things device or backscattering device.

16. An apparatus for wireless communication at a network entity, comprising:
a processor;
memory coupled with the processor; and
instructions stored in the memory and executable by the processor to cause the apparatus to:
transmit a control message indicating a list of a plurality of parameters of a waveform transmission for activating a passive device; and
transmit a resource allocation indicating a plurality of resources allocated for communication between a wireless device and the passive device, the resource allocation comprising a time gap between a first resource of the plurality of resources and a second resource of the plurality of resources.

17. The apparatus of claim 16, wherein the instructions are further executable by the processor to cause the apparatus to:
transmit control signaling indicating a relationship between a duration of the time gap and at least one parameter of the plurality of parameters that is a duration of the waveform transmission.

18. The apparatus of claim 16, wherein the instructions are further executable by the processor to cause the apparatus to:
transmit control signaling indicating a relationship between a duration of the time gap and at least one parameter of the plurality of parameters that is a transmission power level of the waveform transmission.

19. The apparatus of claim 16, wherein the instructions are further executable by the processor to cause the apparatus to:
receive a capability message indicating one or more capabilities of the wireless device; and
transmit, based at least in part on the capability message, the control message indicating the list of the plurality of parameters.

20. The apparatus of claim 19, wherein the one or more capabilities comprise a target communication range, an antenna gain, a defined transmission power level, a number of wireless devices in communication with the passive device, or any combination thereof.

21. The apparatus of claim 16, wherein the instructions are further executable by the processor to cause the apparatus to:
determine the plurality of parameters based at least in part on a target communication range, an antenna gain at the wireless device, a number of wireless devices in communication with the passive device, or any combination thereof.

22. The apparatus of claim 16, wherein the plurality of parameters comprise a waveform transmit power, a waveform transmission duration, or any combination thereof.

23. The apparatus of claim 16, wherein the passive device comprises an internet of things device or backscattering device.

24. A method for wireless communication at a wireless device, comprising:
selecting a first parameter of a waveform transmission for activating a passive device based at least in part on a time gap occurring between a first resource of a plurality of resources and a second resource of the plurality of resources, feedback indicating unsuccessful reception by the passive device of a prior message transmitted by the wireless device, or both; and
transmitting the waveform transmission in accordance with the first parameter.

25. The method of claim 24, further comprising:
receiving a resource allocation indicating the plurality of resources allocated for communication with the passive device.

26. The method of claim 24, further comprising:
receiving control signaling indicating a relationship between a duration of the time gap and the first parameter that is a duration of the waveform transmission.

27. The method of claim 24, further comprising:
receiving control signaling indicating a relationship between a duration of the time gap and the first parameter that is a transmission power level of the waveform transmission.

28. The method of claim 24, further comprising:
receiving control signaling indicating a list comprising at least the first parameter of the waveform transmission for activating the passive device.

29. The method of claim 28, further comprising:
transmitting a capability message indicating one or more capabilities of the wireless device; and
receiving, based at least in part on the capability message, the control signaling indicating the list comprising at least the first parameter of the waveform transmission.

30. A method for wireless communication at a network entity, comprising:
transmitting a control message indicating a list of a plurality of parameters of a waveform transmission for activating a passive device; and
transmitting a resource allocation indicating a plurality of resources allocated for communication between a wireless device and the passive device, the resource allocation comprising a time gap between a first resource of the plurality of resources and a second resource of the plurality of resources.
